(19) United States
(12) Patent Application Publication
(10) Pub. No.: US 2003/0005268 A1
(43) Pub. Date: Jan. 2, 2003

(54) Find first bit value instruction

(76) Inventor: Michael I. Catherwood, Pepperell, MA (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/870,450

(22) Filed: Jun. 1, 2001

(51) Int. Cl. G06F 9/00

(52) U.S. Cl. 712/223

(57) ABSTRACT

Bit operation instructions such as find first bit instructions are provided. The instructions themselves include four instructions for returning a value corresponding to a bit position that stores the first zero or the first one in a memory location beginning from the left or right side of a data word depending on the instruction. Two additional instructions find the first bit change from the left or the right side of a memory location. The instructions operate on data specified in a source register and return a result to a destination register. The source and destination registers may store the data directly or may store pointers to the data. In addition, the instructions may specify the source data as word or byte data.

### FIELD OF THE INVENTION

The present invention relates to systems and methods for instruction processing and, more particularly, to systems and methods for providing bit operation instruction processing, such as find first bit instruction processing, pursuant to which the first zero or one in a memory location beginning on the left or right side is identified.

### BACKGROUND OF THE INVENTION

Processors, including microprocessors, digital signal processors and microcontrollers, operate by running software programs that are embodied in one or more series of instructions stored in a memory. The processors run the software by fetching the instructions from the series of instructions, decoding the instructions and executing them. The instructions themselves control the sequence of functions that the processor performs and the order in which the processor fetches and executes the instructions. For example, the order for fetching and executing each instruction may be inherent in the order of the instructions within the series. Alternatively, instructions such as branch instructions, conditional branch instructions, subroutine calls and other flow control instructions may cause instructions to be fetched and executed out of the inherent order of the instruction series.

When a processor fetches and executes instructions in the inherent order of the instruction series, the processor may execute the instructions very efficiently without wasting processor cycles to determine, for example, where the next instruction is. When flow control instructions are processed, one or more processor cycles may be wasted while the processor locates and fetches the next instruction required for execution.

Processors, including digital signal processors, are conventionally adept at processing instructions that operate on word or byte data. For example, a 16 bit processor is adept at performing operations on 16 bit data. However, the same 16 bit processor is conventionally not adept at performing operations on single bits of data. When bit operations are required, conventionally they are be implemented with a software subroutine or a software loop within a program. Software loops and subroutines make inefficient use of processor resources and tend to reduce the performance of the processor. When, for example, a task management application within a real-time operating system is running on the processor, which tends to rely on bit wise operations implemented in a subroutine, the performance impact may cause impractical delays depending on the application.

Consider the find first instruction. This instruction seeks to find the first zero or one within a memory location. Conventionally, this instruction would have to be implemented in software with a program loop or a subroutine call. The program loop or subroutine would include multiple instructions that either a) perform a masking operation on a register, analyze the result of the register and output the value; or b) perform shifting operations on the value in a memory location until a one or a zero is shifted out of the memory location at one end. Both of these techniques require multiple processor cycles and instructions to implement and accordingly are inefficient.

There is a need for a new method of implementing bit operations within a processor that makes efficient use of processor cycles and instructions efficiently. There is a further need for a new method of implementing find first instructions for bit intensive applications such as task management in real time operating systems and data normalization applications. There is a need for a processor that implements find first operation processing without losing processor cycles to delay associated with flow control instructions.

### SUMMARY OF THE INVENTION

According to embodiments of the present invention, a method and a processor for processing find first instructions are provided. The instructions themselves include four instructions for returning a value corresponding to the bit position that specifies the first zero or the first one beginning from the left or right side of a data word (for LSB and MSB depending on data format and designation). Two additional instructions find the first bit change from the left or the right side. The instructions operate on data specified in a source register and return a result to a destination register. The source and destination registers may store the data directly or may store pointers to the data. In addition, the instructions may specify the source data as word or byte data.

These instructions may be executed in one processor cycle and with one program instruction utilizing bit operation logic within the processor. This represents a significant performance advantage over multiple-instruction software implemented techniques. It also allows smaller programs and accordingly more efficient use of program memory space on a processor. For task management in real-time operating systems and data normalization applications which continuously implement bit manipulation techniques, these instructions may improve performance over conventional techniques by several times. When program loops are implemented to perform the find first operations, order of magnitude performance increases are possible depending on the processor.

A method of processing a bit operation instructions according to an embodiment of the present invention includes fetching and decoding a find first bit instruction. The method further includes executing the find first bit instruction on a source operand to calculate a result corresponding to the first bit position meeting the criteria of the instruction and storing the result. The method may further include setting a flag within a status register when none of the bit positions meet the criteria of the instruction.

The find first bit instruction may be a find first zero or one instruction from the left or right side of a memory location or register. Alternatively, the find first bit instruction may be a find first bit change instruction from the left or right side of a memory location. The instructions may specify the source and destination operands in byte or word width format.

According to another embodiment of the present invention, a processor for find first instruction processing, includes a program memory, a program counter and an arithmetic logic unit (ALU). The program memory for stores instructions including a find first bit instruction. The program counter identifies current instructions for processing. The ALU executes instructions within the program memory and includes bit operation logic for executing the find first bit instruction on a source operand to calculate a result corresponding to the first bit position meeting the criteria of the instruction. The find first bit instruction may be a find first zero or one instruction from the left or right side of a memory location. Alternatively, the find first bit instruction may be a find first bit change instruction from the left or right side of a memory location. The instructions may specify the source and destination operands in byte or word width format.

### BRIEF DESCRIPTION OF THE FIGURES

The above described features and advantages of the present invention will be more fully appreciated with reference to the detailed description and appended figures in which:

FIG. 1 depicts a functional block diagram of an embodiment of a processor chip within which embodiments of the present invention may find application.

FIG. 2 depicts a functional block diagram of a data busing scheme for use in a processor, which has a microcontroller and a digital signal processing engine, within which embodiments of the present invention may find application.

FIG. 3 depicts a functional block diagram of a processor configuration for processing bit operations such as find first bit logic according to embodiments of the present invention.

FIG. 4 depicts a method of processing bit operations such as find first bit operations according to embodiments of the present invention.

FIG. 5 depicts a table of bit operation instructions according to embodiments of the present invention.

FIGS. 6 depicts a block diagram showing an illustrative implementation of the find first bit logic according to an embodiment of the present invention.

### DETAILED DESCRIPTION

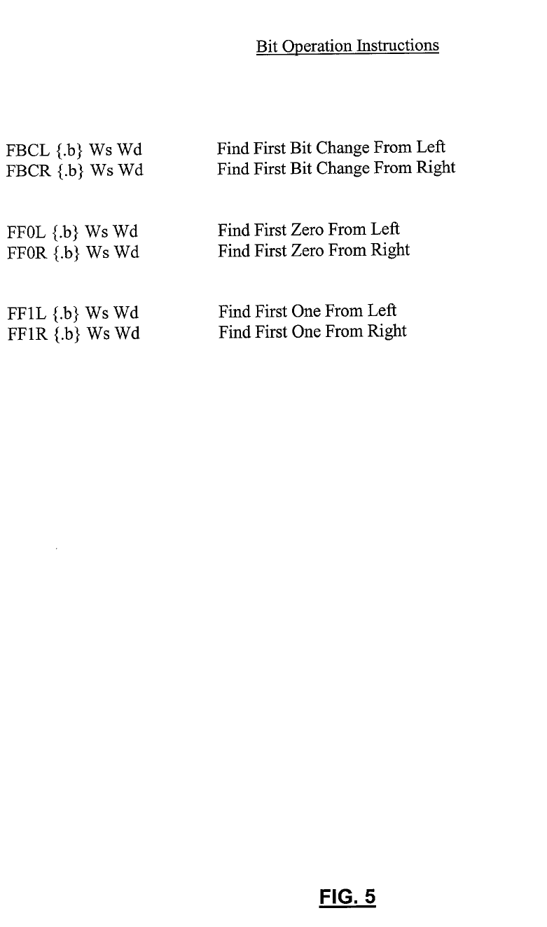

According to an embodiment of the present invention, a processor for processing bit operation instructions such as find first bit instructions is provided. The instructions themselves include four instructions for returning a value corresponding to a bit position that stores the first zero or the first one in a memory location beginning from the left or right side of a data word depending on the instruction. Two additional instructions find the first bit change from the left or the right side of a memory location. The instructions are shown in FIG. 5. The instructions operate on data specified in a source register and return a result to a destination register. The source and destination registers may store the data directly or may store pointers to the data. In addition, the instructions may specify the source data as word or byte data.

These instructions may be executed in one processor cycle and with one program instruction utilizing bit operation logic within the processor. This represents a significant performance advantage over multiple-instruction software implemented techniques. These instructions also allow smaller programs and accordingly more efficient use of program memory space on a processor. For task management in real-time operating systems and data normalization applications which implement frequent bit manipulation operations, these instructions may improve performance over conventional techniques by several times. When compared to program loop implementations for performing bit operations, order of magnitude performance increases are possible depending on the processor.

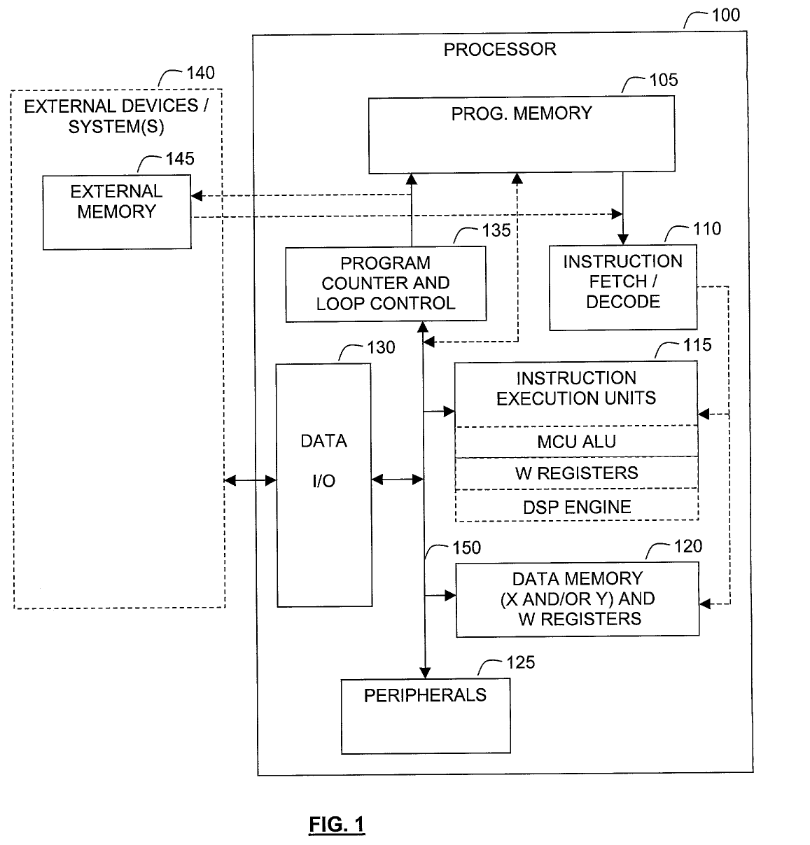

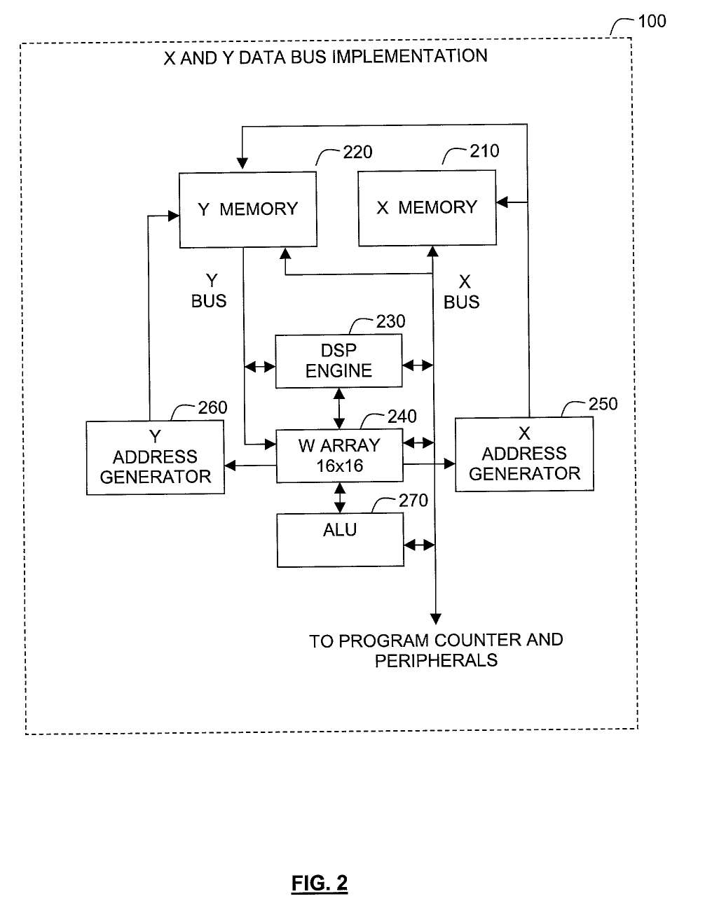

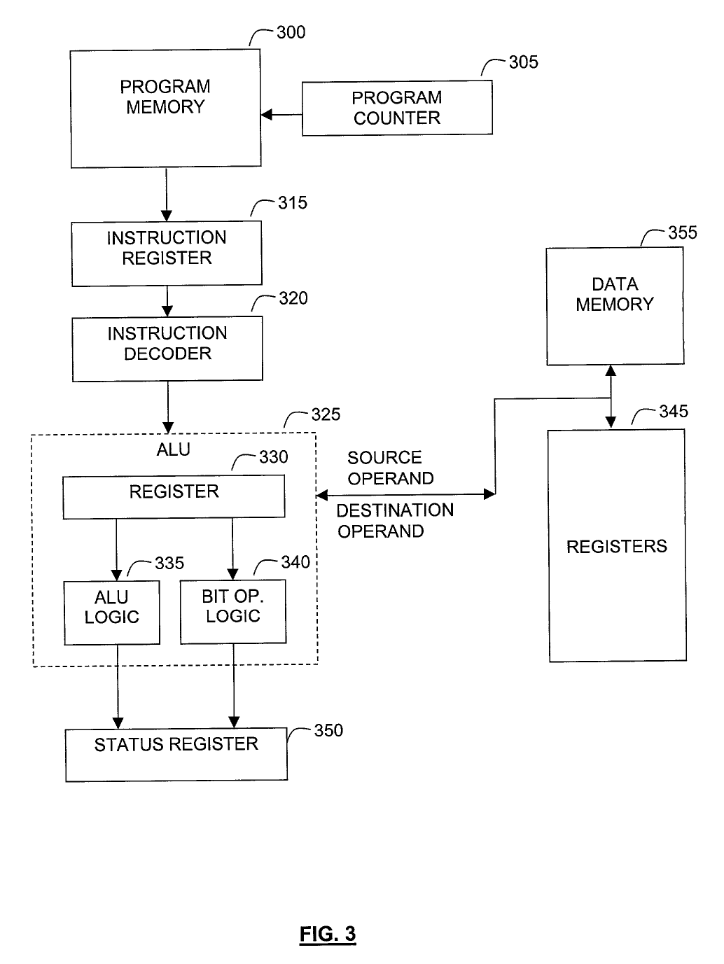

In order to describe embodiments of bit operation instruction processing, an overview of pertinent processor elements is first presented with reference to FIGS. 1 and 2. The bit operation instructions and instruction processing is then described more particularly with reference to FIGS. 3-5.

Overview of Processor Elements

FIG. 1 depicts a functional block diagram of an embodiment of a processor chip within which the present invention may find application. Referring to FIG. 1, a processor 100 is coupled to external devices/systems 140. The processor 100 may be any type of processor including, for example, a digital signal processor (DSP), a microprocessor, a microcontroller or combinations thereof. The external devices 140 may be any type of systems or devices including input/output devices such as keyboards, displays, speakers, microphones, memory, or other systems which may or may not include processors. Moreover, the processor 100 and the external devices 140 may together comprise a stand alone system.

The processor 100 includes a program memory 105, an instruction fetch/decode unit 110, instruction execution units 115, data memory and registers 120, peripherals 125, data I/O 130, and a program counter and loop control unit 135. The bus 150, which may include one or more common buses, communicates data between the units as shown.

The program memory 105 stores software embodied in program instructions for execution by the processor 100. The program memory 105 may comprise any type of nonvolatile memory such as a read only memory (ROM), a programmable read only memory (PROM), an electrically programmable or an electrically programmable and erasable read only memory (EPROM or EEPROM) or flash memory. In addition, the program memory 105 may be supplemented with external nonvolatile memory 145 as shown to increase the complexity of software available to the processor 100. Alternatively, the program memory may be volatile memory which receives program instructions from, for example, an external non-volatile memory 145. When the program memory 105 is nonvolatile memory, the program memory may be programmed at the time of manufacturing the processor 100 or prior to or during implementation of the processor 100 within a system. In the latter scenario, the processor 100 may be programmed through a process called in-line serial programming.

The instruction fetch/decode unit 110 is coupled to the program memory 105, the instruction execution units 115 and the data memory 120. Coupled to the program memory 105 and the bus 150 is the program counter and loop control unit 135. The instruction fetch/decode unit 110 fetches the instructions from the program memory 105 specified by the address value contained in the program counter 135. The instruction fetch/decode unit 110 then decodes the fetched instructions and sends the decoded instructions to the appropriate execution unit 115. The instruction fetch/decode unit 110 may also send operand information including addresses of data to the data memory 120 and to functional elements that access the registers.

The program counter and loop control unit 135 includes a program counter register (not shown) which stores an address of the next instruction to be fetched. During normal instruction processing, the program counter register may be incremented to cause sequential instructions to be fetched. Alternatively, the program counter value may be altered by loading a new value into it via the bus 150. The new value may be derived based on decoding and executing a flow control instruction such as, for example, a branch instruction. In addition, the loop control portion of the program counter and loop control unit 135 may be used to provide repeat instruction processing and repeat loop control as further described below.

The instruction execution units 115 receive the decoded instructions from the instruction fetch/decode unit 110 and thereafter execute the decoded instructions. As part of this process, the execution units may retrieve one or two operands via the bus 150 and store the result into a register or memory location within the data memory 120. The execution units may include an arithmetic logic unit (ALU) such as those typically found in a microcontroller. The execution units may also include a digital signal processing engine, a floating point processor, an integer processor or any other convenient execution unit. A preferred embodiment of the execution units and their interaction with the bus 150, which may include one or more buses, is presented in more detail below with reference to FIG. 2.

The data memory and registers 120 are volatile memory and are used to store data used and generated by the execution units. The data memory 120 and program memory 105 are preferably separate memories for storing data and program instructions respectively. This format is a known generally as a Harvard architecture. It is noted, however, that according to the present invention, the architecture may be a Von-Neuman architecture or a modified Harvard architecture which permits the use of some program space for data space. A dotted line is shown, for example, connecting the program memory 105 to the bus 150. This path may include logic for aligning data reads from program space such as, for example, during table reads from program space to data memory 120.

Referring again to FIG. 1, a plurality of peripherals 125 on the processor may be coupled to the bus 125. The peripherals may include, for example, analog to digital converters, timers, bus interfaces and protocols such as, for example, the controller area network (CAN) protocol or the Universal Serial Bus (USB) protocol and other peripherals. The peripherals exchange data over the bus 150 with the other units.

The data I/O unit 130 may include transceivers and other logic for interfacing with the external devices/systems 140. The data I/O unit 130 may further include functionality to permit in circuit serial programming of the Program memory through the data I/O unit 130.

FIG. 2 depicts a functional block diagram of a data busing scheme for use in a processor 100, such as that shown in FIG. 1, which has an integrated microcontroller arithmetic logic unit (ALU) 270 and a digital signal processing (DSP) engine 230. This configuration may be used to integrate DSP functionality to an existing microcontroller core. Referring to FIG. 2, the data memory 120 of FIG. 1 is implemented as two separate memories: an X-memory 210 and a Y-memory 220, each being respectively addressable by an X-address generator 250 and a Y-address generator 260. The X-address generator may also permit addressing the Y-memory space thus making the data space appear like a single contiguous memory space when addressed from the X address generator. The bus 150 may be implemented as two buses, one for each of the X and Y memory, to permit simultaneous fetching of data from the X and Y memories.

The W registers 240 are general purpose address and/or data registers. The DSP engine 230 is coupled to both the X and Y memory buses and to the W registers 240. The DSP engine 230 may simultaneously fetch data from each the X and Y memory, execute instructions which operate on the simultaneously fetched data and write the result to an accumulator (not shown) and write a prior result to X or Y memory or to the W registers 240 within a single processor cycle.

In one embodiment, the ALU 270 may be coupled only to the X memory bus and may only fetch data from the X bus. However, the X and Y memories 210 and 220 may be addressed as a single memory space by the X address generator in order to make the data memory segregation transparent to the ALU 270. The memory locations within the X and Y memories may be addressed by values stored in the W registers 240.

Any processor clocking scheme may be implemented for fetching and executing instructions. A specific example follows, however, to illustrate an embodiment of the present invention. Each instruction cycle is comprised of four Q clock cycles Q1-Q4. The four phase Q cycles provide timing signals to coordinate the decode, read, process data and write data portions of each instruction cycle.

According to one embodiment of the processor 100, the processor 100 concurrently performs two operations—it fetches the next instruction and executes the present instruction. Accordingly, the two processes occur simultaneously. The following sequence of events may comprise, for example, the fetch instruction cycle:

| | |
|---|---|
| Q1: | Fetch Instruction |
| Q2: | Fetch Instruction |
| Q3: | Fetch Instruction |
| Q4: | Latch Instruction into prefetch register, Increment PC |

The following sequence of events may comprise, for example, the execute instruction cycle for a single operand instruction:

| | |
|---|---|
| Q1: | latch instruction into IR, decode and determine addresses of |
| | operand data |
| Q2: | fetch operand |
| Q3: | execute function specified by instruction and calculate destination |
| | address for data |
| Q4: | write result to destination |

The following sequence of events may comprise, for example, the execute instruction cycle for a dual operand instruction using a data pre-fetch mechanism. These instructions pre-fetch the dual operands simultaneously from the X and Y data memories and store them into registers specified in the instruction. They simultaneously allow instruction execution on the operands fetched during the previous cycle.

| | |
|---|---|
| Q1: | latch instruction into IR, decode and determine addresses of |
| | operand data |
| Q2: | pre-fetch operands into specified registers, execute operation in |
| | instruction |
| Q3: | execute operation in instruction, calculate destination address for |
| | data |
| Q4: | complete execution, write result to destination |

Bit Operation Instruction Processing

FIG. 3 depicts a functional block diagram of a processor for processing bit operations according to the present invention. Referring to FIG. 3, the processor includes a program memory 300 for storing instructions such as the bit operation instructions depicted in FIG. 5. The processor also includes a program counter 305 which stores a pointer to the next program instruction that is to be fetched. The processor further includes an instruction register 315 for storing an instruction for execution that has been fetched from the program memory 300. The processor may further include pre-fetch registers or an instruction pipeline (not shown) that may be used for fetching and storing a series of upcoming instructions for decoding and execution. The processor also includes an instruction decoder 320, an arithmetic logic unit (ALU) 325, registers 345 and a status register 350.

The instruction decoder 320 decodes instructions that are stored in the instruction register 315. Based on the bits in the instruction, the instruction decoder 320 selectively activates logic within the ALU 325 for fetching operands, performing the specified operation on the operands and returning the result to the appropriate memory location.

The ALU 325 includes registers 330 that receive operands from the registers 345 and/or a data memory 355 depending on the addressing mode used in the instruction. For example in one addressing mode, the source and/or destination operand data may be stored in the registers 345. In another addressing mode, the source and/or destination operand data may be stored in the data memory 355. Alternatively, some operands may be stored in registers 345 while others may be stored in the memory 355.

The ALU 325 includes ALU logic 335 and bit operation logic 340, each of which receives inputs from the registers 330 and produces outputs to the registers 345 and a status register 350. The ALU logic 335 executes arithmetic and logic operations according to instructions decoded by the instruction decoder on operands fetched from the registers 345 and/or from the data memory 345. In general, the ALU 335 processes data in byte or word widths.

The instruction decoder 320 decodes particular instructions and sends control signals to the ALU which direct the fetching of the correct operands specified in the instruction, direct the activation of the correct portion of the ALU logic 335 to carry out the operation specified by the instruction on the correct operands, direct the result to be written to the correct destination and direct the status register to store pertinent data when present, such as a status flag indicating a zero result.

The bit operation logic 340 may be part of or separate from the ALU logic 335. The bit operation logic is, however, is logically separate from the ALU logic 335 and is activated upon the execution of one of the bit operation instructions shown in FIG. 5. In this regard, when a bit operation instruction such as one of those depicted in FIG. 5 is present in the instruction decoder 320, the instruction decoder generates control signals which cause the ALU to fetch the specified source operand from the registers 345 or from the data memory 355 and which cause the bit operation logic 340 to operate on the fetched source operand to produce a result. The result depends upon the instruction executed and the source operand as is explained below in more detail. After generating the result, the instruction decoder causes the result to be written back into the correct register 345 or memory location within the data memory 355.

The bit operation logic may include logic for implementing six different bit operation instructions such as those depicted in FIG. 5. Each of these instructions find the first bit within a memory location matching a predetermined criteria based upon the instruction as indicated in the table of FIG. 5. Each instruction may specify that the value tested may be a byte stored at a particular memory location or may be a word stored at a particular memory location. The instruction may further specify the source and destination operands as data stored in specified registers, data stored in a memory and pointed to by a pointer stored in specified registers. The instruction may also specify that the pointer may be pre or post incremented or decremented as part of the instruction execution.

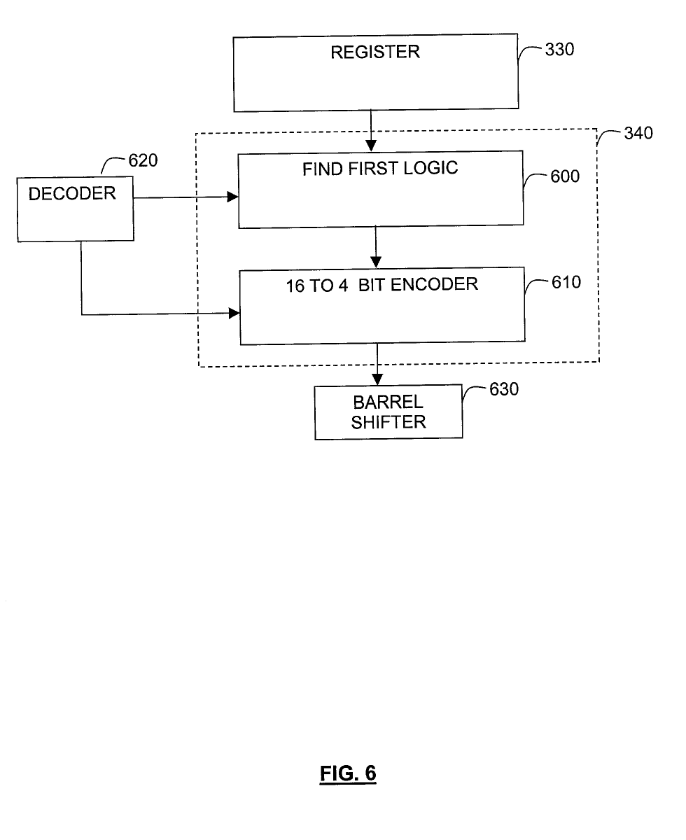

The logic for implementing each instruction is selectively activated by the instruction decoder 320 when that particular instruction is decoded. An illustrative example of logic that may be used to implement each instruction is shown in FIG. 6.

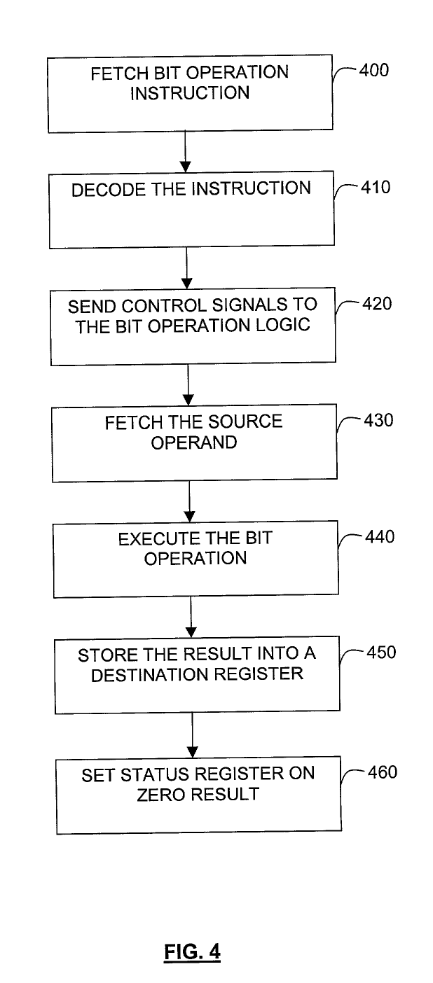

FIG. 4 depicts a method of processing bit operation instructions such as find first instructions according to embodiments of the present invention. Referring to FIG. 4, in step 400, the processor fetches a bit operation instruction from the program memory 300. Then in step 410, the instruction decoder 320 decodes the instruction. In step 420, the processor causes control signals to be sent to the ALU 325 and the bit operation logic 340 within the ALU.

In step 430, the ALU fetches the source operand from the find first instruction from the specified memory location within the register 345 or the data memory 355. In step 440, the processor executes the bit operation instruction decoded. Then in step 450, the processor stores the result into a destination register. In step 460, if a zero result is produced a zero flag is set in the status register 350. A zero result may be produced, for example, when no bits of the memory location tested meet the criteria of the find first instruction. For example, a find first one instruction executed on a value of zero would return a value of zero.

FIG. 6 depicts a block diagram of an illustrative bit operation logic 340 and surrounding elements for implementing find first instructions. Referring to FIG. 6, the registers 330 provide input to the find first logic 600 within the bit operation logic 340. The find first logic 600 receives control signals from the instruction decoder 620. When a find first instruction is decoded, the instruction decoder 620 sends control signals to the find first logic to cause the find first logic to perform a masking operation on the value received from the register 330 which in the illustrative embodiment is a 16 bit value. The masking operation performed is determined by the particular type of find first instruction. In general, the masking operation may produce a value of all zeros except for the bit position occupied by the first zero (or one) from the left or right or the first bit change depending on the instruction. The masked value is then output to an encoder 610.

The encoder 610 receives control signals from the instruction decoder 620. When a find first instruction is decoded, the instruction decoder sends appropriate control signals to configure the encoder to perform a translation of a 16 bit value to a 4 bit value. The translated 4 bit value is indicative of the number of the bit position of the one within the masked value measured either from the left or the right depending on the instruction. A FFOL instruction will produce a 4 bit output from the 16 to 4 bit encoder 610 that is measured from the left. A FF0L instruction will produce a 4 bit output from the 16 to 4 bit encoder 610 that is measured from the left.

The value output from the encoder 610 maybe fed into a barrel shifter 630 for normalization operations. Alternatively, the value output from the encoder 610 may be provided to the registers 345 or the data memory 355.

While specific embodiments of the present invention have been illustrated and described, it will be understood by those having ordinary skill in the art that changes may be made to those embodiments without departing from the spirit and scope of the invention.

What is claimed is:

1. A method of processing a bit operation instruction, comprising:
fetching and decoding a find first bit instruction;
executing the find first bit instruction on a source operand to calculate a result corresponding to the first bit position meeting the criteria of the instruction;
storing the result.

2. The method according to claim 1, further comprising setting a zero flag within a status register when none of the bit positions meet the criteria of the instruction.

3. The method according to claim 1, wherein the instruction is a find first zero instruction.

4. The method according to claim 3, wherein the find first zero instruction finds the first zero from the left side of a memory location.

5. The method according to claim 3, wherein the find first zero instruction finds the first zero from the left side of a memory location.

6. The method according to claim 1, wherein the instruction is a find first one instruction.

7. The method according to claim 6, wherein the find first one instruction finds the first one from the left side of a memory location.

8. The method according to claim 3, wherein the find first one instruction finds the first one from the left side of a memory location.

9. The method according to claim 1, wherein the instruction is a find first bit change instruction.

10. The method according to claim 9, wherein the find first bit change instruction finds the first bit change from the left side of a memory location.

11. The method according to claim 9, wherein the find first bit change instruction finds the first bit change from the right side of a memory location.

12. The method according to claim 1, wherein the find first bit instruction specifies the source operand.

13. The method according to claim 1, wherein the find first bit instruction specifies a byte of a memory location that stores the source operand.

14. A processor for find first instruction processing, comprising:
a program memory for storing instructions including a find first bit instruction;
a program counter for identifying current instructions for processing;
an arithmetic logic unit (ALU) for executing instructions within the program memory, the ALU including bit operation logic for executing the find first bit instruction on a source operand to calculate a result corresponding to the first bit position meeting the criteria of the instruction.

15. The processor according to claim 14, further comprising setting a zero flag within a status register when none of the bit positions meet the criteria of the instruction.

16. The processor according to claim 14 wherein the instruction is a find first zero instruction.

17. The processor according to claim 16, wherein the find first zero instruction finds the first zero from the left side of a memory location.

18. The processor according to claim 16, wherein the find first zero instruction finds the first zero from the right side of a memory location.

19. The processor according to claim 14, wherein the instruction is a find first one instruction.

20. The processor according to claim 19, wherein the find first one instruction finds the first one from the left side of a memory location.

21. The processor according to claim 19, wherein the find first one instruction finds the first one from the right side of a memory location.

22. The processor according to claim 14, wherein the instruction is a find first bit change instruction.

23. The processor according to claim 22, wherein the find first bit change instruction finds the first bit change from the left side of a memory location.

24. The processor according to claim 22, wherein the find first bit change instruction finds the first bit change from the right side of a memory location.
